(19) United States
(12) Patent Application Publication
(10) Pub. No.: US 2005/0036723 A1
(43) Pub. Date: Feb. 17, 2005

(54) Rolling bearing for fan motor

(76) Inventors: Kiyoshi Okuda, Fujisawa-shi (JP); Nobuaki Izawa, Fujisawa-shi (JP); Mitsuru Saitou, Fujisawa-shi (JP)

Correspondence Address: KATTEN MUCHIN ZAVIS ROSENMAN, 575 MADISON AVENUE, NEW YORK, NY, 10022-2585, US

(21) Appl. No.: 10/921,782

(22) Filed: Aug. 19, 2004

Related U.S. Application Data
(63) Continuation of application No. PCT/JP03/01864, filed on Feb. 20, 2003.

(30) Foreign Application Priority Data
Feb. 20, 2002 (JP) 2002-042594

(51) Int. Cl. F16C 19/00; F16C 33/76

(52) U.S. Cl. 384/463; 384/477

(57) ABSTRACT

The inner races 11 of ball bearings 7a, 7b are securely fitted by interference fit onto the portion of a rotatable shaft 5 whose outer diameter is not changed over the axial direction in order to support the rotatable shaft 5 in a motor case 4. In this state, the above respective ball bearings 7a and 7b are preloaded. The temperature of the above inner races 11 can reach 130□ or a higher temperature in use. These inner races 11 are made of a steel containing its retained austenite in an amount of up to 4% by volume. The interference of the inner races 11 with the above rotatable shaft 5 is secured by inhibiting enlargement of the above inner races 11 in inner diameter due to the decomposition of the retained austenite. Accordingly, an air conditioning apparatus for automobile is realized with a structure which can be manufactured at a low cost, securing preload even in a high temperature environment, without giving riders discomfortable feeling.

### CROSS-REFERENCE TO RELATED APPLICATION

The present application is a continuation of International Application No. PCT/JP03/01864 which was filed on Feb. 20, 2003.

### TECHNICAL FIELD

The rolling bearing for fan motor in accordance with the present invention is used for supporting the rotatable shaft of a fan motor which is installed in an air conditioning system for automobile to exhaust conditioned air into the compartment of the automobile.

### BACKGROUND OF THE INVENTION

An air conditioning system for automobile includes, from the upstream in turn in a duct provided for circulating a ventilation air, a centrifugal multi-blade fan for circulating an air as taken from an opening at the upstream end through this duct, an evaporator for cooling the air, a heater core for warming the air, and a bypass conduit for short-circuiting this heater core. In the operation of the air conditioning system for automobile, the air taken from the inside or outside of the automobile compartment by the rotation of the above centrifugal multi-blade fan is passed through the above evaporator, and then passed through one or both of the above heater core and the bypass conduit, followed by blowing the air through an opening at the downstream end into the inside of the automobile compartment. The temperature of the blown air is adjusted by changing the amount of the cooling medium or hot water passed through the above evaporator and the heater core, and the ratio between the air amounts passed through this heater core and the above bypass conduit.

The above centrifugal multi-blade fan is rotationally driven by a fan motor installed in a side wall portion at the upstream end of the above duct and projected from this duct. FIG. 1 is a view showing an example such a fan motor. At first, the structure of this fan motor 1 will be briefly explained. In the example as illustrated, the motor case 4 of the above fan motor 1 is supported by a support member 3 located in the side wall portion of a duct 2 at the upstream end thereof, and the tip portion of the rotatable shaft 5 of this fan motor 1 (the right end of FIG. 1) which is extending from the above motor case 4 is projected toward the inside of the above duct 2. A centrifugal multi-blade fan, which is not shown in the figure, is fixed to the tip portion of the rotatable shaft 5 as described above.

Inside a pair of cylinder members 6a and 6b located in the opposite sides of the above motor case 4 in the axial direction (the right and left direction in FIG. 1), ball bearings 7a and 7b which are the subjects of the present invention respectively are provided for rotatably supporting the above rotatable shaft 5 at the base end portion (the left end of FIG. 1) and at a location in the center thereof displaced a little to the tip end. Each of these ball bearings 7a and 7b is composed of an outer race 9 having a deep groove type outer raceway 8 with a cross section in the form of an arc, and an inner race 11 having a deep groove type inner raceway 10 with a cross section in the form of an arc, and a plurality of balls 12 and 12 which are rolling members respectively rollingly supported between the outer raceway 8 and the inner raceway 10. The respective balls 12 and 12 are supported by retainers, not shown in the figure, in order that they are rollingly supported apart from each other in the circumferential direction.

A rotor 13 and a commutator 14 are fixed at the intermediate portion of the above rotatable shaft 5 between the above respective ball bearings 7a and 7b. On the other hand, a stator 15 is fixed to the inner peripheral surface of the above motor case 4 facing the above rotor 13, while brushes 16 are provided opposite the above commutator 14, in order that the above rotatable shaft 5 is rotatably driven by the energization of the above rotor 13.

So far, by virtue of the improvement of the silence property of an automobile in recent years, it is required to suppress the noise generated in the vicinity of the fan motor 1 to a very low level. To this end, attempts have been made to preload the above respective ball bearings 7a and 7b for the purpose of avoiding any lost motion of the rotationally supported portion of the above rotatable shaft 5. In this case, in order to preload the above respective ball bearings 7a and 7b, the inner races 11 and 11 of the respective ball bearings 7a and 7b are securely fitted onto the outer peripheral surface of the above rotatable shaft 5 (in the state inhibiting the movement in the axial direction). On the other hand, the outer races 9 and 9 of the above respective ball bearings 7a and 7b are urged toward each other.

Furthermore, to meet the demand for lower costs in recent years, it has been proposed to make the above rotatable shaft 5 from a simple round bar whose outer diameter is constant over the axial direction for the purpose of reducing the processing costs of the respective constituent parts of the above fan motor 1. Namely, if the respective inner races 11 and 11 are fitted onto and supported by the above rotatable shaft 5 in order not to move in the axial direction by forming a step in the outer peripheral surface of this rotatable shaft 5 or by forming an engaging groove for locking a snap ring, the costs increase by the formation. Because of this, it can be thought to reduce the costs by securely fitting the respective inner races 11 and 11 by interference fit onto the portion of the above rotatable shaft 5 whose outer diameter is not changed over the axial direction.

FIG. 1 shows a structure designed taking into consideration this point. The outer race 9 of the ball bearing 7a supporting the above rotatable shaft 5 at a location in the center thereof displaced to the tip end is fitted into a cylindrical support member 6a located at the tip portion of said motor case 4 such that the movement of the outer race 9 toward the tip end is inhibited. On the other hand, the outer race 9 of the ball bearing 7b supporting the above rotatable shaft 5 at the base end portion is fitted into a cylindrical support member 6b located at the base end portion of said motor case 4 such that the movement of the outer race 9 in the axial direction is permitted. Then, this outer race 9 is urged toward the tip end by a preload spring 17 provided between the bottom surface of this cylindrical support member 6b and the above outer race 9. In this condition, the outer races 9 and 9 of the above respective ball bearings 7a and 7b are preloaded at a contact angle in a face-to-face combination fashion.

However, it was found by the investigation of the present inventors that a preload cannot be constantly applied in the long term use when a conventionally used rolling bearing for fan motor was installed into the structure as shown in FIG. 1. Namely, in the case of the rolling bearings which have been conventionally used for fan motor, the outer race 9, the inner race 11 and the balls 12 and 12 are made of a steel (bearing steel in general) containing the retained austenite in an amount of about 10% by volume (γ_{R}). However, the austenite is decomposed at a high temperature of the order of 130□ into martensite while the volume thereof is slightly increased. For example, if the retained austenite contained in the steel constituting the inner race 11 is decomposed, the volume of this inner race 11 is expanded to increase the inner diameter thereof. As a result, the interference of this inner race 11 with the above rotatable shaft 5 is decreased or lost, and therefore the possibility occurs that this inner race 11 moves relative to this rotatable shaft 5 in the axial direction due to the axial load by the preload. Particularly, keeping costs low and size small for fuel economy in recent years, in the case where a cooling apparatus is omitted from a fan motor, it is likely that the temperature of the above inner race 11 is elevated to the level to accelerate the decomposition of the above austenite.

Anyway, when the above inner race 11 moves in the axial direction due to the load on the basis of the preload as described above, the preload on the above respective ball bearings 7a and 7b is decreased or lost (escape of the preload), and therefore the support rigidity of the above rotatable shaft 5 is lowered. When the support rigidity of the rotatable shaft 5 is lowered in this manner, the noise and vibration generated during the rotation of this rotatable shaft 5 increase. Namely, if the above support rigidity is lowered, the run-out of the centrifugal multi-blade fan supported by the tip portion of the above rotatable shaft 5 increases in the radial direction. Then, the vibration of this centrifugal multi-blade fan itself and the vibration of the duct 2 located around this centrifugal multi-blade fan increase, resulting in large noise due to this vibration, and it is therefore undesirable since discomfort is caused to the occupant.

The rolling bearing for fan motor in accordance with the present invention is made taking into consideration the above circumstances.

### DISCLOSURE OF THE INVENTION

The rolling bearing for fan motor in accordance with the present invention comprises an outer race having an outer raceway on its inner peripheral surface, an inner race having an inner raceway on its outer peripheral surface, and a plurality of rolling members rollingly provided between the outer raceway and the inner raceway.

Then, for the purpose of supporting in a motor case the rotatable shaft of a fan motor for rotationally driving a blower fan, the above inner race is securely fitted under a preload by interference fit onto the portion of the above rotatable shaft whose outer diameter is not changed over the axial direction between a portion of the inner peripheral surface of the motor case and the outer peripheral surface of the rotatable shaft.

Also, the temperature of the above inner races can reach 130□ or a higher temperature in use.

Particularly, in the case of the rolling bearing for fan motor according to the present invention, at least the above inner race contains its retained austenite in an amount up to 4% by volume.

Also, in a more preferred implementation, the amount of the retained austenite contained in the above inner race contains is up to 2% by volume.

Furthermore, in a more preferred implementation, the amount of the retained austenite contained in the above outer race is also up to 4% (preferably up to 2%) by volume.

In accordance with the rolling bearing for fan motor of the present invention as described above, it is possible to prevent the interference of the inner race with the rotatable shaft from being lowered and thereby prevent the preload applied to the rolling bearing from being lowered. Namely, since the amount of the retained austenite is restricted to up to 4% in the steel constituting the inner race, it is possible to inhibit the expansion of the above inner race even if the retained austenite is decomposed when the temperature of this inner race rises and converted into martensite. For this reason, the expansion ratio of this inner race in inner diameter can be inhibited so small as not to affect the interference with the above rotatable shaft. As a result, even after the long term use at high temperatures, it is possible to secure the support rigidity of the above rotatable shaft and prevent noise from being enlarged.

Also, if the amount of the retained austenite contained in the above inner race is restricted up to 2% by volume, the loss of the above preload can more effectively be inhibited.

Furthermore, by making the outer race and the respective rolling members of a steel containing the retained austenite in an amount of up tp 4% (more preferably up to 2%) by volume in the same manner as the above inner race, it is possible to inhibit the expansion of the above outer race in inner diameter and surely prevent the lowering of the preload applied to the rolling bearing.

### BRIEF DESCRIPTION OD THE DRAWINGS

FIG. 1 is a cross sectional brief view of a fun motor with a rolling bearing for the present invention installed.

### BEST MODE FOR CARRYING OUT THE INVENTION

A feature of the invention is that the preload on the rolling bearing for supporting the rotatable shaft of the fan motor in a motor case is prevented from being decreased or lost by restricting the amount of the retained austenite in the inner race of the rolling bearing. With respect to the structure as illustrated in the figure, the structures are similar to those as described above, and therefore redundant explanation is not repeated for equivalent functionality. In what follows, the result of an experiment conducted for the purpose of confirming the advantages of the present invention will be explained.

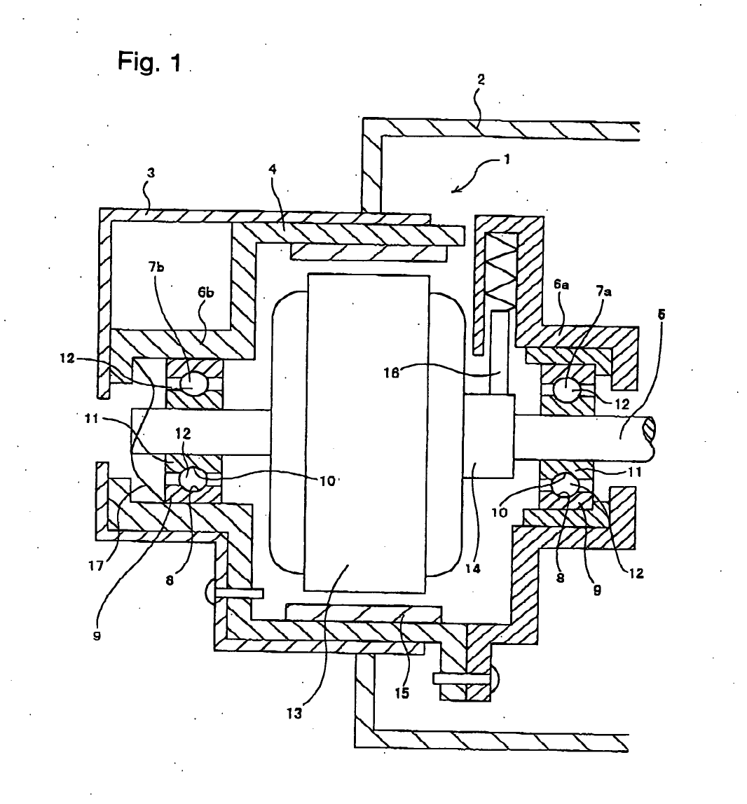

In the experiment, the structure as illustrated in FIG. 1 was driven, in order that the temperature of the above inner race 11 reached 1300, with varying the retained austenite amount (γ_{R}) in six steps in the range of 0% to 10% by volume contained in the steel constituting the inner races 11 of the ball bearings 7a and 7b under preload for supporting the rotatable shaft 5. Then, it was confirmed after the driving whether or not the preload of the respective ball bearings 7a and 7b is decreased or lost (escape of the preload). The result of the experiment conducted in this manner is shown in the following table 1.

TABLE 1

| γ_{R} (% by volume) | Escape of the Preload |
|---|---|
| 10 | yes |
| 7 | yes |
| 5 | yes |
| 4 | none |
| 2 | none |
| 0 | none |

As apparent from the result of the experiment as shown in this table 1, it is possible to prevent the preload even at a high temperature from being lowered (escape of the preload) by restricting the amount of the retained austenite (γ_{R}) up to 4% by volume.

Incidentally, while the pair of ball bearings 7a and 7b are arranged at a contact angle in a face-to-face combination fashion in the example as illustrated, the present invention can be embodied with a pair of ball bearings arranged at a contact angle in a back-to-back combination fashion. In this case, the outer races of both the ball bearings are fitted into and supported by the motor case in order not to move toward each other. Then, the inner races of the respective ball bearings are securely fitted by interference fit onto the portion of the above rotatable shaft, whose outer diameter is not changed over the axial direction, with an urging force exerting them to move toward each other. Also in this case, it is possible to inhibit the expansion of the inner race in inner diameter due to temperature elevation and prevent the preload from escaping by restricting the amount of the retained austenite up to 4% (more preferably up to 2%) by volume in the steel constituting the inner race of the above respective ball bearings. Incidentally, as compared with the face-to-face combination type, it is easy by arranging a pair of ball bearings at a contact angle in a back-to-back combination fashion to furthermore improve the support rigidity of the above rotatable shaft and reduce the noise generated during the rotation of the blower fan.

### INDUSTRIAL APPLICABILITY

Since the rolling bearing for fan motor in accordance with the present invention is constructed and operated as mentioned above, it is possible to realize an air conditioning system for automobile which can be manufactured at a low cost and in which a preload is maintained even in a high temperature environment without causing discomfort to the occupant.

1. A rolling bearing for fan motor located between a portion of an inner peripheral surface of a motor case and an outer peripheral surface of a rotatable shaft for rotationally driving a blower fan, and provided for rotatably supporting said rotatable shaft in relation to said motor case, said rolling bearing for fan motor comprising an outer race, an inner race and a plurality of rolling members, wherein
(1) the outer race is
(1a) provided with an outer raceway on an inner peripheral surface,
(2) the inner race is
(2a) provided with an inner raceway on an outer peripheral surface;
(2b) securely fitted by interference fit onto a portion of the rotatable shaft whose outer diameter is not changed over the axial direction and given a preload;
(2c) heated in use to a temperature which can reach 130□ or a higher temperature; and
(2d) made of a steel containing a retained austenite in an amount of up to 4% by volume,
(3) the rolling members are
(3a) rollingly supported between the outer raceway and the inner raceway.

2. The rolling bearing for fan motor as claimed in claim 1 wherein the amount of the retained austenite contained in the inner race is up to 2% by volume.

3. The rolling bearing for fan motor as claimed claim 1 wherein the amount of the retained austenite contained in the outer race is also up to 4% by volume in the same manner as that of the inner race.

4. The rolling bearing for fan motor as claimed claim 1 which is an angular or deep groove type ball bearing with the outer raceway and the inner raceway having an arc configuration in cross section, and the rolling members in the form of balls.

5. The rolling bearing for fan motor comprising a pair structure with the rolling bearing for fan motor claimed in claim 1 located in two positions of the rotatable shaft apart from each other in the axial direction, wherein
(1) the inner race is
(1a) securely fitted by interference fit onto a portion of the rotatable shaft whose outer diameter is not changed over the axial direction;
(2) the outer races are arranged such that
(2a) one outer race is fitted into and supported by a part of the motor case in order to be urged toward the other outer race;
(2b) the other outer race is fitted into and supported by a part of the motor case in order not to move in the axial direction irrespective of an urging force.

6. The rolling bearing for fan motor as claimed in claim 1 wherein the blower fan is a centrifugal multi-blade fan located at the upstream end of the duct constituting an air conditioning system for automobile.

7. A fan motor implemented with the rolling bearing for fan motor as recited in claim 1.

8. A fan motor implemented with a pair structure of rolling bearings for fan motor as recited in claim 5.
